(19) United States
(12) Patent Application Publication
(10) Pub. No.: US 2006/0275334 A1
(43) Pub. Date: Dec. 7, 2006

(54) Parasiticidal composition

(76) Inventor: Jasmina Dokic-Gallagher, Manchester (GB)

Correspondence Address: DUANE MORRIS, LLP;IP DEPARTMENT, 30 SOUTH 17TH STREET, PHILADELPHIA, PA, 19103-4196, US

(21) Appl. No.: 10/566,747

(22) PCT Filed: Jul. 29, 2004
(86) PCT No.: PCT/GB04/03297

§ 371 Date: Jun. 13, 2006

(30) Foreign Application Priority Data
Aug. 2, 2003 (GB) 0318160.9

(51) Int. Cl. A01N 25/00

(52) U.S. Cl. 424/405

(57) ABSTRACT

A parasiticidal composition comprising, as an active ingredient, at least one bioadhesive polymer and salts thereof together with at least one physiologically acceptable carrier.

The present invention relates to a parasiticidal composition which finds particular utility in the control of head lice infestation in humans.

Lice infestation in humans is generally caused by insects from the families Pediculidae and Pthiridas, in particular Pediculus humanus species and Pthirus pubis. Head lice infestations are caused in particular by Pediculus humanus capitis.

The control of parasite infestation such as head lice has recently been managed by mosaic policies, with insecticides from the group consisting of dichlorodiphenyl trichloroethane (DDT), cyclodienes, organophosphates, carbamates and pyrethyroids as well as ‘herbal’ remedies such as tea-tree oil or other naturally derived terpenoid sources.

Head lice are known to become resistant to treatments, thus, to ensure availability of a diversity of insecticidal treatments there is a continuing requirement for novel insecticides to ensure suitable mosaic policies are maintained.

It is an object of the present invention to seek to provide alternative novel insecticides for the treatment of head lice.

According to a first aspect of the present invention there is provided a parasiticidal composition comprising as an active ingredient at least one bioadhesive polymer and salts thereof together with at least one physiologically acceptable carrier.

Surprisingly, it has been found that bioadhesive polymers are highly effective in killing parasites and in particular those parasites responsible for head lice infestation. Thus, bioadhesive polymers have been found to have pediculicidal (that is, they kill lice) and ovicidal (that is, they kill lice eggs) activity.

As referred to herein the term bioadhesive polymers, includes but is not limited to, carbomer related substances, natural gums, thickeners, gelling agents and cellulose derivatives.

Preferably, the bioadhesive polymer constitutes from 0.25 to 10% w/w of the total composition.

Preferably, the bioadhesive polymers of the present invention are carbomer related substances (hereinafter referred to as carbomer(s)). Carbomers are high molecular weight network polymers consisting of acrylic acid backbones cross linked with polyalkenyl ethers. Typically carbomers have a molecular weight in the range of from 700 000 to 3-4 billion.

Where the bioadhesive polymer is a carbomer the said substance shall preferably constitute from 0.25 to 2.0% w/w of the total composition.

The physiologically acceptable carrier may be any suitable chemical entity that is compatible with human physiology and the bioadhesive polymer.

Examples of suitable physiologically acceptable carriers, which may be used alone or in combination, include alcohols such as isopropanol (IPA), ethanol and industrial methylated spirit (IMS), water and silicone based compounds such as cyclomethicone.

Generally, where present water constitutes a maximum of 99.75% w/w of the total composition.

Where the composition comprises more than one physiologically acceptable carrier, water may be added up to 100% w/w.

The composition of the present invention may further comprise at least one surfactant selected from any of the following either alone or in combination: anionic, cationic, non-ionic, amphoteric or zwitterionic agents.

The anionic surfactants may be selected from any of the following either alone or in combination: monovalent alkyl carboxylates, polyvalent alkyl carboxylates, acyl lactylates, alkyl ether carboxylates, N-acyl sarcosinates, N-acyl glutamates, fatty acid-polypeptide condensates, sulphuric acid esters, ester-linked sulphonates, alpha olefin sulphonates and phosphated ethoxylated alcohols.

The cationic surfactants may be selected from any of the following either alone or in combination: monoalkyl and dialkyl quaternary ammonium compounds, amidoamines and aminimides.

The non-ionic surfactants may be selected from any of the following either alone or in combination: polyoxyalcohols, polyoxypropylenes, amine oxides, fatty acid esters and polyhydric alcohols.

The amphoteric/zwitterionic surfactants may be selected from any of the following either alone or in combination: triglycerides, e.g. lecithin, N-substituted alkyl amides, N-alkyl betaines, sulphobetaines and N-alkyl beta aminopropionates.

The aforementioned surfactants may also impart emulsifying properties to the composition of the present invention.

Preferably the pH of the composition of the present invention is in the range from 4.5 to 8.0.

The composition of the present invention may include additional ingredients, for example co-monomers such as C₁₀-C₃₀ alkyl acrylates. These alkyl acrylates are used to hydrophobically modify homopolymer carbomers to improve their electrolyte tolerance.

In one embodiment of the present invention the composition comprises from 0.25 to 1.0% w/w carbomer together with up to 10% w/w of a cyclicsiloxane or an hydroxy-terminated linear siloxane. Preferably, the cyclic siloxane is decamethylcyclopentasiloxane.

In a further embodiment of the present invention the composition comprises from 0.25 to 1.0% w/w carbomer together with up to 60% w/w of an alcohol component. Preferably, the alcohol component is IPA which constitutes from 10 to 30% w/w.

In a further embodiment of the present invention the composition comprises from 0.25 to 1.0% w/w of carbomer together with up to 10% w/w of a silicone component and from 10 to 30% w/w of IPA.

In a still further embodiment of the present invention the composition comprises from 0.25 to 1.0% w/w of carbomer together with at least one surfactant and IPA.

The composition of the present invention may further comprise a component having additional ovicidal activity. Such constituents result in the destruction of louse eggs even when the composition is in contact with hair for a relatively short period of time

Suitable ovicidal agents include terpenes and terpenoids such as those referred to in WO 00/64265, preferably one or both of d-limonene and geranyl acetate.

The composition of the present invention may be combined with at least one other pediculicidal and/or ovicidal agent such as d-phenothrin, malathion, carbaryl as well as natural ingredients such as tea tree oil and neem oil. Such agents may act synergistically with the composition of the present invention such that the efficacy of the composition is enhanced.

In a still further embodiment of the present invention the composition comprises carbomer, surfactant, IPA and a component which delivers ovicidal activity.

The composition of the present invention is thought to form a bioadhesive polymer network on the surface of the louse and egg. Thus, the composition is thought to be acting by suffocation and/or affecting water/electrolyte elimination or retention in the louse/eggs i.e. osmoregulation.

According to the second aspect of the present invention there is provided a bioadhesive polymer for use in the treatment of lice in humans.

According to the third aspect of the present invention there is provided the use of at least one bioadhesive polymer in the preparation of a composition for the treatment of lice in humans.

According to the fourth aspect of the present invention there is provided a process for the preparation of a parasiticidal composition as hereinbefore defined comprising the step of: bringing together at least one bioadhesive polymer and salts thereof and at least one physiologically acceptable carrier.

Preferably, the composition of the present invention is adapted for topical application to a subject.

Therefore, the composition of the present invention may be provided in any suitable form to allow such application, for example a gel, lotion, liquid, mousse (aerosol and non-aerosol), shampoo, crème rinse, serum, spray or emulsion for the hair.

Unless otherwise stated, all quantities referred to herein are measured by weight of the total composition.

The present invention will now be described further by way of example only with reference to the following experimental results.

Method of Testing the Pediculicidal/Ovicidal Activity of a Composition

Samples of Carbopol® Ultrez 21 (manufactured by Noveon, Inc. and stated to be a hydrophobically modified cross-linked polyacrylate polymer) were used as an example of carbomers. Other carbomers may include but are not limited to Carbopol® Ultrez 10, Carbopol® ETD 2020 and 2050, Carbopol® 980, 981, 971, 71G 1382, 2984, 5984, 934, 940, 941, 1342.

The selected carbomer was wetted with water and then dispersed in additional water, using a high shear mixer with, to form a gel or solution with the appropriate % w/w carbomer content. Finally, pH was adjusted to pH 4.5 to pH 8.0, preferably pH 5.0 to pH 6.0, with NaOH solution or triethanolamine.

Measurement of Activity by Immersion

Human lice, Pediculus humanus, were tested by Insect R&D Limited, Cambridge, UK. Adult female and male lice, in approximately equal numbers, were used for each test. The lice were fed on the morning of the test and allowed a minimum of 4 hours to recover, during which time they were able to excrete excess water imbibed with their blood meal. Lice were counted into batches that were provided with squares of open meshed nylon gauze (tulle), as a substrate upon which to stand, and each batch allocated to a marked 30-millimeter plastic Petri dish.

Louse eggs, Pediculus humanus, were tested by Insect R&D Limited, Cambridge, UK. They were obtained by providing actively laying adult lice with a close meshed nylon substrate, in place of the normal cotton corduroy substrate, over a 48 hour period. At the end of this time the insects were removed and the gauze cut into appropriately sized smaller pieces. The small gauze pieces were randomly allocated to plastic Petri dishes in advance of the test.

For the test procedure an aliquot of approximately 5 millilitres of test solution was poured onto the base of a clean 30 millimetre plastic Petri dish. The gauze bearing the lice/eggs was immersed in the fluid for 10 seconds, during which time the gauze was turned at least twice to ensure removal of air bubbles. After removal from the fluid the gauze and eggs were lightly blotted to remove any excess and returned to the marked Petri dish. In the case of gels, an aliquot of approximately 5 millilitres of gel was placed on the palm of the hand and the lice/eggs gently rubbed in the gel for 10 seconds. Hands were washed thoroughly between test gels.

Gauze squares bearing lice/eggs were incubated under normal maintenance conditions (30°±2° Celsius. and 50%±15% relative humidity) for the remainder of the test period. At the end of the appropriate time the lice/eggs were washed for 30 seconds, using a 1:15 mixture of Boots® frequent wash shampoo in tap water, and rinsed three times in warm (35° Celsius.) tap water, poured over and through the gauze, followed by blotting with a medical wipe tissue. The gauze squares with their lice/eggs were then incubated under normal maintenance conditions until the results were recorded. Observations of the mortality of the lice were recorded after 24 hours and of louse eggs when the control group had completed emergence, a minimum of 10 days after treatment.

For most tests, lice and eggs were exposed to the treatment overnight. However, the effects of different exposure times, from 10 minutes to 8 hours, were also assessed for some test formulations.

A control comparison test was performed using 60% propan-2-ol (isopropanol), which is routinely used in our laboratory and causes minimum mortality to lice, in place of carbomer gels. All other procedures for this comparator were the same as for the test groups. The IPA control test was usually run at the end of each set of tests, but was also occasionally run at the beginning as well as at the end of a set of tests.

Results

Medical grade materials (or National Formulary, NF, grade) were used where available.

### EXAMPLE 1

Carbopol® Ultrez 21 was wetted with water, and then dispersed in further water to form a gel containing 0.5% w/w carbomer. The pH of the gel was adjusted to a pH of 5.0 and 6.0. The pediculicidal and ovicidal efficacy of the gel was then assessed according to the Measurement of Activity by Immersion test method already described, following overnight exposure. Most dead lice had burst guts so that they took on a dark red colour throughout the tissue.

Percent pediculicidal efficacy was calculated from the formula:

$$PE = \frac{{L}_{Dead} + {L}_{Moribund}}{{L}_{Total}} \times 100 \% OR PE = \frac{{L}_{Total} - {L}_{Alive}}{{L}_{Total}} \times 100 \%$$

where:
L_{Dead}=number of lice assessed as dead at end of exposure period
L_{Moribund}=number of lice assessed as moribund at end of exposure period (‘moribund’ includes any state in which the insect is deemed to be non-viable and unlikely to continue life at the time of observation; such insects may show only the slightest of movements of a limb or part of the gut but the category extends through walking insects that are considered sufficiently lacking in co-ordination that they would be unable to hold onto their substrate, feed or lay eggs)
L_{Total}=total number of lice exposed to test formulation
L_{Alive}=number of lice assessed as alive and viable at end of exposure period
PE=percent mortality or uncorrected pediculicidal efficacy

Percent ovicidal efficacy was calculated from the formula:

$$OE = \frac{{O}_{Undeveloped} + {O}_{Dead} + {O}_{Half - hatched}}{{O}_{Total}} \times 100 \% OR$$

$$OE = \frac{{O}_{Total} - {O}_{Hatched}}{{O}_{Total}} \times 100 \%$$

where:
O_{Undeveloped}=number of eggs assessed as undeveloped (not hatched) at end of exposure period
O_{Dead}=number of eggs in which the embryo died (as shown by the lack of eye-spot or malformed eye-spot)
O_{Half-hatched}=number of eggs from which a louse was killed whilst emerging from the egg
O_{Total}=total number of eggs exposed to test formulation
O_{Hatched}=number of eggs that hatched successfully
OE=percent mortality or uncorrected ovicidal efficacy

Efficacy percentages were corrected using Abbott's formula (A method of computing the effectiveness of an insecticide, Abbott W S, Journal of Economic Entomology, 18; pp 265-7 (1925)). This is a simple formula used to adjust observed test mortality data to allow for any mortality in control groups:

$${PE}_{C} or {OE}_{C} = \frac{T - C}{100 - C} \times 100 \%$$

where:
   PE_{C}=corrected percent pediculicidal efficacy or mortality
   OE_{C}=corrected percent ovicidal efficacy or mortality
   T=uncorrected percent efficacy in test group
   C=uncorrected percent efficacy in control group

In the following Tables, all pediculicidal or ovicidal efficacy data under “Mortality (%)” are the corrected pediculicidal or ovicidal data. Differences between lice and eggs from different batches and within different batches mean that the results from any particular assessment can be subject to about a 10% error. Therefore all efficacy results have been rounded to the nearest 10% where appropriate.

The pediculicidal efficacy results for 0.5% Ultrez 21 are given in Table 1. It was found to be 100% effective after overnight treatment.

### EXAMPLES 2-9a

The efficacy of a range of carbomers was evaluated by preparing formulations containing between 0.05% w/w to 2.0% w/w carbomer, in water and adjusting the pH of the resulting mix to between pH 5.0 to pH 6.0. Although gels containing more than 2.0% w/w carbomer were made and were 100% effective, their high viscosity made them unsuitable for use without adjustment of the formulation by the addition of appropriate diluents to reduce the viscosity of the gel to a suitable level.

Although 0.05% w/w carbomer showed some efficacy against lice overnight, this was considered too low to provide an effective product. However, levels of 0.25% w/w and above were totally effective against lice overnight. 1.0% carbomer was totally effective after only 2 hours and 60% effective after only 10 minutes. In all cases, the IPA controls showed between 10-30% efficacy against lice overnight (average of 20%).

TABLE 1
Pediculicidal efficacy of a range of carbomers

| | | | | Mortality |
|---|---|---|---|---|
| | Carbomer | % w/w | Time | (%) |
| Example 2 | Ultrez Polymer 10 | 0.05 | overnight | 30 |
| Example 3 | Carbopol 980NF | 0.05 | overnight | 30 |
| Example 4 | Ultrez Polymer 10 | 0.25 | overnight | 100 |
| Example 5 | Carbopol 980NF | 0.25 | overnight | 100 |
| Example 1 | Ultrez Polymer 21 | 0.5 | overnight | 100 |
| Example 6 | Ultrez Polymer 10 | 0.5 | overnight | 100 |
| Example 7 | Carbopol 980NF | 0.5 | overnight | 100 |
| Example 8 | Carbopol 980NF | 1.0 | overnight | 100 |
| Example 9 | Ultrez Polymer 10 | 1.0 | 10 minutes | 60 |
| Example 9a | Ultrez Polymer 10 | 2.0 | overnight | 100 |
| Control (60% | Control (60% IPA) | — | overnight | 20 |
| IPA) | | | | |

### EXAMPLES 10-16

A range of other bioadhesive polymers was evaluated for pediculicidal efficacy, using the same procedure as outlined previously for the evaluation of the carbomers. The results of the assessment are given in Table 2.

The viscosity modifying properties of the various polymers are different and therefore some can be used at much higher concentrations to achieve similar gels to the other polymers. As can be seen from the results, it was possible to formulate pediculicidally effective gels from all of the bioadhesive polymers evaluated.

TABLE 2
Pediculicidal efficacy of a range of bioadhesive polymers

| | | | | Mortality |
|---|---|---|---|---|
| | Polymer | % w/w | Time | (%) |
| Example 1 | Ultrez 21 | 0.5 | overnight | 100 |
| Example 10 | CMC-7HF¹ | 2.0 | overnight | 70 |
| Example 11 | | 4.0 | overnight | 100 |
| Example 12 | Kollidon ® 90F² | 4.0 | overnight | 60 |
| Example 12a | | 10.0 | overnight | 100 |
| Example 13 | Tragacanth³ | 2.0 | overnight | 90 |
| Example 14 | Methocel E15LV⁴ | 4.0 | overnight | 60 |
| Example 14a | | 10.0 | overnight | 100 |
| Example 15 | Polycarbophil AA1⁵ | 1.0 | overnight | 100 |
| Example 16 | Guar gum⁶ | 0.5 | overnight | 100 |
| Control (60% | Control (60% IPA) | — | overnight | 20 |
| IPA) | | | | |

¹CMC-7HF - sodium carboxymethylcellulose gum from Hercules, Inc
²Kollidon ® 90F - polyvinylpyrrolidone from BASF, Inc.
³Tragacanth gum - complex mixture of acidic polysaccharides (available from ISP Food Specialties (UK) Ltd)
⁴Methocel ® E15LV - cellulose methyl ether from Dow Chemical Inc
⁵Polycarbophil AA1 - a copolymer of acrylic acid and divinylglycol, from Noveon Inc
⁶Guar Gum - polysaccharides based on galactomannan (available from Thew Arnott & Co Ltd)

### EXAMPLES 17-22

It has been found that a number of process aids can enhance the efficacy of the bioadhesive polymers gels, and in particular the carbomer gels. For example, the inclusion of an alcohol in the formulation, or a cyclic silicone, can both lead to enhanced pediculicidal and/or ovicidal efficacy.

The gels were prepared as previously except that the cyclomethicone or IPA was added before or after the addition of the carbomer to the water, but before the pH was adjusted. The gels were tested as previously described and the results for pediculicidal efficacy are given in Table 3 and for ovicidal efficacy in Table 4.

TABLE 3
Pediculicidal efficacy of including alcohol or cyclic siloxane

| | Formulation (% w/w) | | | | | |
|---|---|---|---|---|---|---|
| Component | Example 8 | Example 17 | Example 18 | Example 18a | Example 19 | Control |
| Carbomer | 1.0 | 1.0 | 1.0 | 1.0 | 1.0 | 60% IPA |
| ST-cyclomethicone 5 | — | 10.0 | — | — | — | |
| IPA | — | — | 20.0 | 30.0 | 60.0 | |
| % Efficacy at 10 | 60 | 100 | — | — | — | — |
| minutes | | | | | | |
| % Efficacy at 2 hours | — | — | — | 80 | 100 | — |
| % Efficacy at 4 hours | — | — | — | — | — | — |
| % Overnight efficacy | 100 | — | 100 | — | — | 20 |

ST-cyclomethicone 5 (from Dow Corning) = decamethylcyclopentasiloxane

The addition of 10% w/w cyclomethicone (Example 17) improved the 100% efficacy time for 1.0% w/w carbomer from overnight to about ten minutes. IPA on the other hand has little impact at relatively low IPA levels (up to at least 20% w/w) whereas high levels of IPA (at least 60% w/w) lead to a significant increase in pediculicidal efficacy.

TABLE 4
Ovicidal efficacy of including alcohol

| | Formulation (% w/w) | | | |
|---|---|---|---|---|
| Component | Example 20 | Example 21 | Example 22 | Control |
| Carbomer | 2.0 | 1.0 | 1.0 | 60% IPA |
| IPA | — | 20.0 | 60.0 | |
| % Efficacy at 2 | — | — | 30 | 10 |
| hours | | | | |
| % Overnight | 30 | 30 | — | 20 |
| efficacy | | | | |

As can be seen, 2.0% w/w carbomer on its own has only 30% ovicidal efficacy overnight. The addition of low levels of IPA (up to at least 20% w/w) to 1% W/W carbomer gel maintained the efficacy seen at the higher carbomer level, and higher levels of IPA (of up to 60% w/w) improved the ovicidal efficacy still further.

### EXAMPLES 23-25

The impact of using both an alcohol and a cyclic siloxane in the carbomer gel formulation was also assessed.

TABLE 5
Pediculicidal efficacy of including alcohol and cyclic siloxane

| | Formulation (% w/w) | | | | |
|---|---|---|---|---|---|
| Component | Example 1 | Example 23 | Example 24 | Example 25 | Control |
| Carbomer | 0.5 | 0.5 | 1.0 | 1.0 | 60% IPA |
| ST-cyclomethicone 5 | — | 10.0 | 5.0 | 8.0 | |
| Isopropanol (IPA) | — | 20.0 | 30.0 | 20.0 | |
| % Efficacy at 10 minutes | — | — | — | 100 | — |
| % Efficacy at 2 hours | — | 100 | 100 | — | — |
| % Efficacy at 4 hours | — | — | — | — | — |
| % Overnight efficacy | 100 | — | — | — | 20 |

As can be seen from Table 5, the inclusion of 10% w/w cyclic siloxane and 20% w/w IPA to 0.5% carbomer gel improved the 100% efficacy time from overnight to 2 hours. The 100% efficacy time was reduced further, to 10 minutes by increasing the carbomer level to 1.0% w/w and incorporating 8% w/w cyclic siloxane and 20% w/w IPA.

### EXAMPLE 26-30

Gels were prepared containing 0.5% w/w D-Phenothrin to evaluate the pediculicidal and ovicidal efficacies of gels containing a range of bioadhesive polymers.

TABLE 6
Pediculicidal and ovicidal efficacy of formulations containing D-
Phenothrin

| | Formulation (% w/w) | | | | | |
|---|---|---|---|---|---|---|
| Component | Example 26 | Example 27 | Example 28 | Example 29 | Example 30 | Control |
| CMC 7MF | 4.0 | — | — | — | — | 60% IPA |
| Kollidon ® 90F | — | 10.0 | — | — | — | |
| Methocel ® E15LV | — | — | 10 | — | — | |
| Polycarbophil AA1 | — | — | — | 1 | — | |
| Guar gum | — | — | — | — | 1 | |
| ST-cyclomethicone 5 | — | — | 5 | — | — | |
| Isopropanol (IPA) | — | — | 10 | — | — | |
| Propylene glycol | 10 | 10 | — | 10 | 10 | |
| D-Phenothrin | 0.5 | 0.5 | 0.5 | 0.5 | 0.5 | |

% Pediculicidal and ovicidal efficacy [overnight]

| | | | | | | |
|---|---|---|---|---|---|---|
| Pediculicidal | 100 | 100 | 100 | 100 | 100 | 20 |
| Ovicidal | 100 | 100 | 100 | 100 | 100 | 10 |

### EXAMPLES 31-35

The pH of the gel formulation was varied from pH 4.5 to pH 8.0 to assess whether pH had an impact on pediculicidal or ovicidal efficacy. The results are given in Table 7

TABLE 7
Effect of pH on pediculicidal and ovicidal efficacy of carbomer gels

| | Formulation (% w/w) and pH | | | | | |
|---|---|---|---|---|---|---|
| | Example | | | | | |
| | 31 | 32 | 33 | 34 | 35 | |
| Component | pH4.5 | pH5.0 | pH6.0 | pH7.0 | pH8.0 | Control |

| | | |
|---|---|---|
| Carbomer | 0.5 | 60% IPA |
| SLS | 0.05 | |
| IPA | 10.0 | |

% Pediculicidal and ovicidal efficacy [overnight]

| | | | | | | |
|---|---|---|---|---|---|---|
| Pediculicidal | 100 | 100 | 100 | 100 | 100 | 10 |
| Ovicidal | 70 | 90 | 100 | 100 | 80 | 10 |

SLS = sodium lauryl sulphate (an anionic surfactant)

As can be seen from the results, changing the pH from pH4.5 to pH8.0 had no impact on the pediculicidal efficacy of the carbomer gel though the ovicidal efficacy is optimal between pH 5 to pH 7.

### EXAMPLES 36-38

The efficacy of gels containing 0.5% w/w carbomer can also be enhanced by the addition of a surfactant to the gel. Addition of 0.05% w/w SLS (sodium laurly sulphate) or 5.0% w/w Softigen® 767 (PEG-6 caprylic/capric glyceride, Hüls (UK) Ltd) enhances the ovicidal efficacy of 0.5% w/w carbomer to 100% overnight.

TABLE 8
Pediculicidal and ovicidal efficacy of carbomer gels containing a
surfactant

| | Formulation (% w/w) | | | |
|---|---|---|---|---|
| Component | Example 36 | Example 37 | Example 38 | Control |
| Carbomer | 0.5 | 0.5 | 0.5 | 60% |
| SLS | — | — | 0.05 | IPA |
| Softigen ® 767 | — | 5.0 | — | |
| ST-cyclomethicone | — | — | — | |
| 5 | | | | |
| IPA | — | 1 | 10 | |
| % Pediculicidal | 100 | 100 | 100 | 20 |
| efficacy [overnight] | | | | |
| % Ovicidal efficacy | — | 100 | 100 | 10 |
| [overnight] | | | | |

Formulations

Formulations that can be prepared in accordance with this invention include hair gels, lotions, liquids, mousses (aerosol and non-aerosol), shampoos, creme rinses, sprays or emulsion for the hair treatments. The precise nature and qualities of additional constituents that are required will vary according to the desired properties of the final product. The skilled formulator will be familiar with such constituents and their usage, which can include but it is not limited to, for example, silicone compounds, suspending agents, emulsifying agents, surfactants, foaming agents and foam boosters, alcohol, emollients, preservatives, colourings and perfumes.

To enhance activity of the compositions according to the invention it has been found that further constituents having ovicidal activity can be added without adversely affecting their efficacy. These further constituents are terpenes and in particular, the terpenes d-limonene and geranyl acetate can be used, each at a concentration of from 0.2% v/v to 1% v/v.

It is of course to be understood that the invention is not intended to be restricted to the details of the above embodiments which are described by way of example only.

1. A parasiticidal composition comprising, as an active ingredient, at least one bioadhesive polymer and pharmaceutically acceptable salts thereof together with at least one physiologically acceptable carrier.

2. A composition according to claim 1, wherein the bioadhesive polymer constitutes from 0.25 to 10% w/w of the total composition.

3. A composition according to claim 1, wherein the bioadhesive polymer is a carbomer related substance.

4. A composition according to claim 3, wherein the carbomer related substance constitutes from 0.25 to 20% w/w of the total composition.

5. A composition according to claim 1 wherein the physiological carrier is selected from any of the following either alone or in combination: alcohols, water and silicone based compounds.

6. A composition according to claim 5, wherein the alcohols are selected from any of the following either alone or in combination: isopropanol, ethanol and industrial methylated spirit.

7. A composition according to claim 5, wherein the silicone based compounds are selected from any of the following either alone or in combination: cyclomethicone, hydroxy-terminated linear siloxane.

8. A composition according to claim 1 wherein the composition further contains at least one surfactant.

9. (canceled)

10. (canceled)

11. (canceled)

12. (canceled)

13. (canceled)

14. A composition according to claim 1 wherein the composition further comprises co-monomers.

15. (canceled)

16. A composition according to claim 1 wherein the composition further comprises at least one additional component having ovicidal activity.

17. A composition according to claim 16, wherein the additional component having ovicidal activity is selected from any of the following either alone or in combination: terpenes, d-phenothrin, malathion, carbaryl, tea tree oil and neem oil.

18. A composition according to claim 1 wherein the composition comprises 0.25 to 1.0% w/w carbomer together with up to 10% w/w of a cyclic siloxane.

19. A composition according to claim 18, wherein the cyclic siloxane, is decamethyl cyclopentasiloxane.

20. A composition according to claim 1 wherein the composition comprises from 0.25 to 1.0% w/w carbomer together with up to 60% w/w of an alcohol component.

21. (canceled)

22. A composition according to claim 20, wherein the alcohol constitutes from 10 to 30% w/w of the total composition,

23. A composition according to claim 1 wherein the composition comprises: from 0.25 to 1.0 w/w carbomer together with up to 10% w/w of a silicone component and from 10 to 30% w/w of IPA.

24. A composition according to claim 1 wherein the composition comprises from 0.25 to 1.0 w/w carbomer together with at least one surfactant and IPA.

25. A composition according to claim 1 wherein the composition comprises at least one carbomer, at least one surfactant, IPA and an additional component which delivers ovicidal activity.

26. (canceled)

27. (canceled)

28. A process for the preparation of a parasiticidal composition as described in claim 1, comprising the steps of: bringing together at least one bioadhesive polymer, and salts thereof; and at least one physiologically acceptable carrier.
